(19) United States
(12) Patent Application Publication
(10) Pub. No.: US 2026/0095692 A1
(43) Pub. Date: Apr. 2, 2026

(54) MICROPHONE MODULE, SPEAKER MODULE AND COMMUNICATION DEVICE

(71) Applicant: Wistron Corporation, New Taipei City (TW)

(72) Inventors: Chao Yung Chen, New Taipei City (TW); Yung Hsin Chou, New Taipei City (TW); Hsin Hung Chou, New Taipei City (TW)

(73) Assignee: Wistron Corporation, New Taipei City (TW)

(21) Appl. No.: 18/940,835

(22) Filed: Nov. 8, 2024

(30) Foreign Application Priority Data
Sep. 27, 2024 (TW) 113136952

(51) Int. Cl. H04R 1/28; H04M 1/03; H04R 1/02; H04R 1/08

(52) U.S. Cl. CPC H04R 1/2896; H04M 1/035; H04R 1/025; H04R 1/08; H04R 1/288

(57) ABSTRACT

A microphone module includes a carrying structure and a microphone assembly. The carrying structure includes a carrying part and two supporting parts, and the two supporting parts are connected to the carrying part. The microphone assembly includes a microphone body part and two hanging parts, the microphone body is suspended on the carrying part, and the two hanging parts are respectively connected to two opposite sides of the microphone body part and hung on the two supporting parts respectively. In addition, a speaker module and a communication device are also mentioned.

### CROSS-REFERENCE TO RELATED APPLICATION

This application claims the priority benefit of Taiwan application serial no. 113136952, filed on Sep. 27, 2024. The entirety of the above-mentioned patent application is hereby incorporated by reference herein and made a part of this specification.

### BACKGROUND

### Technical Field

The disclosure relates to an acoustic module and a communication device having the same, and in particular to a microphone module, a speaker module, and a communication device having the same.

### Description of Related Art

Communication devices such as telephones and conference machines include microphones and speakers. The sound receiving quality of the microphone and the broadcast quality of the speaker can be adjusted and optimized through software, while the impact of the vibration of the speaker on the sound receiving quality and the broadcast quality can only be suppressed through structural design. However, the communication devices currently on the market do not solve the vibration issue properly through structural design.

### SUMMARY

The disclosure provides a microphone module, a speaker module, and a communication device, which can effectively suppress the impact of the vibration of the speaker on the sound receiving quality and broadcast quality.

The microphone module of the disclosure includes a carrying structure and a microphone assembly. The carrying structure includes a carrying part and two supporting parts, and the two supporting parts are connected to the carrying part. The microphone assembly includes a microphone body part and two hanging parts, the microphone body is suspended on the carrying part, and the two hanging parts are respectively connected to two opposite sides of the microphone body part and hung on the two support parts respectively.

In an embodiment of the disclosure, each of the supporting parts has a limiting notch, and each of the hanging parts is limited in the limiting notch of the corresponding supporting part.

In an embodiment of the disclosure, each of the hanging parts has two blocking flanges, and each of the supporting parts is blocked between the two blocking flanges of the corresponding hanging part.

In an embodiment of the disclosure, the microphone body part includes a housing and a microphone. The two hanging parts are connected to two opposite sides of the housing, and the microphone is configured in the housing.

In an embodiment of the disclosure, the two hanging parts are integrally formed and connected to the housing.

In an embodiment of the disclosure, a horizontal axis passes through the two hanging parts along a width direction of the microphone assembly. In an up-down direction of the microphone assembly, the horizontal axis does not pass through a geometric center of the microphone.

In an embodiment of the disclosure, the horizontal axis passes through the two hanging parts along the width direction of the microphone assembly. In a front-rear direction of the microphone assembly, the horizontal axis does not pass through the geometric center of the microphone body.

In an embodiment of the disclosure, the microphone module further includes a sealing member and a covering structure. The sealing member is compressed between the covering structure and the carrying part and defines a sealing area, and the microphone assembly is located in the sealing area.

The speaker module of the disclosure includes the carrying structure, a speaker assembly, and a screwing member. The carrying structure includes a carrying part and an assembly part, and the assembly part is connected to the carrying part. The speaker assembly is configured on the carrying part and includes a speaker body part and a buffer structure. The buffer structure includes a buffer part. The buffer part is located on a first surface of the speaker body part. The assembly part penetrates the buffer part. The screwing member is screwed on the assembly part, and the buffer part is sandwiched between the screwing member and the first surface of the speaker body part.

In an embodiment of the disclosure, the number of the assembly part, the buffer part, and the screwing member is multiple. The assembly parts respectively penetrate the buffer parts, and the screwing members are respectively screwed on the assembly parts.

In an embodiment of the disclosure, the buffer structure includes a buffer layer. The buffer layer is located on a second surface of the speaker body part relative to the first surface and is connected to the buffer part. The buffer layer is sandwiched between the second surface of the speaker body part and the carrying part.

In an embodiment of the disclosure, a peripheral edge of the speaker body part has an assembly notch, and the buffer part and the buffer layer are connected to each other through the assembly notch.

In an embodiment of the disclosure, the speaker module further includes a covering structure and an annular sealing structure. The carrying part has an annular flange. The annular flange defines a sound cavity area, and the speaker assembly is located in the sound cavity area. The annular sealing structure has a groove. The annular flange is embedded in the groove, and the annular sealing structure is compressed between the covering structure and the annular flange.

In an embodiment of the disclosure, the speaker module further includes the covering structure. A rear sound cavity is formed between the covering structure and the buffer structure, and a front sound cavity is formed between the buffer structure and the carrying part.

The communication device of the disclosure includes a first cover, a microphone module, and a speaker module. The microphone module includes a carrying structure and a microphone assembly. The carrying structure is formed on the first cover and includes a carrying part and two supporting parts. The two supporting parts are connected to the carrying part. The microphone assembly includes a microphone body part and two hanging parts, the microphone body is suspended on the carrying part, and the two hanging parts are respectively connected to the two opposite sides of the microphone body part and hung on the two supporting parts respectively. The speaker module includes another carrying structure, a speaker assembly, and a screwing member. The another carrying structure is formed on the first cover and includes another carrying part and an assembly part. The assembly part is connected to the another carrying part. The speaker assembly is configured on the another carrying part and includes a speaker body part and a buffer structure. The buffer structure includes a buffer part. The buffer part is located on the first surface of the speaker body part. The assembly part penetrates the buffer part. The screwing member is screwed on the assembly part. The buffer part is sandwiched between the screwing member and the first surface of the speaker body part.

In an embodiment of the disclosure, the communication device further includes a second cover. The second cover is assembled to the first cover. The microphone module further includes the sealing member and the covering structure. The covering structure is formed on the second cover. The sealing member is compressed between the covering structure and the carrying part and defines the sealing area. The microphone assembly is located in the sealing area.

In an embodiment of the disclosure, the speaker module is located outside the sealing area.

In an embodiment of the disclosure, the communication device further includes the second cover. The second cover is assembled to the first cover. The speaker module further includes the covering structure and the annular sealing structure. The covering structure forms on the second cover. The carrying part has the annular flange. The annular flange defines the sound cavity area. The speaker assembly is located in the sound cavity area. The annular sealing structure has the groove. The annular flange is embedded in the groove. The annular sealing structure is compressed between the cover structure and the annular flange.

In an embodiment of the disclosure, the microphone module is located outside the sound cavity area.

In an embodiment of the disclosure, the communication device further includes the second cover, and the second cover is assembled to the first cover. The speaker module further includes the covering structure, and the covering structure is formed on the second cover. The rear sound cavity is formed between the covering structure and the buffer structure, and the front sound cavity is formed between the buffer structure and the another carrying part.

### BRIEF DESCRIPTION OF THE DRAWINGS

FIG. 1 is a perspective view of a communication device according to an embodiment of the disclosure.

FIG. 2 is an exploded view of the communication device in FIG. 1.

FIG. 3 is a partial bottom view of some components of the communication device in FIG. 2.

FIG. 4 is a partial enlarged view of the communication device in FIG. 3.

FIG. 5 is a front view of the microphone module in FIG. 4.

FIG. 6 is a perspective view of the microphone assembly in FIG. 5.

FIG. 7 is a cross-sectional view along line II of the communication device in FIG. 1.

FIG. 8 is a perspective view of the microphone module in FIG. 4.

FIG. 9 is a partial perspective view of the communication device in FIG. 3.

FIG. 10 illustrates a partial structure of the speaker module in FIG. 9.

FIG. 11 is a perspective view of a speaker assembly in FIG. 9.

FIG. 12 is a bottom view of a buffer structure in FIG. 11.

FIG. 13 is a side view of the buffer structure in FIG. 12.

FIG. 14 is a cross-sectional view along line II-II of the communication device in FIG. 1.

FIGS. 15 and 16 are perspective views of the partial structure of the speaker module in FIG. 14.

FIG. 17 is an enlarged partial cross-sectional view of the speaker module in FIG. 15.

FIGS. 18A to 18C are test charts of the broadcast effect of the communication device in

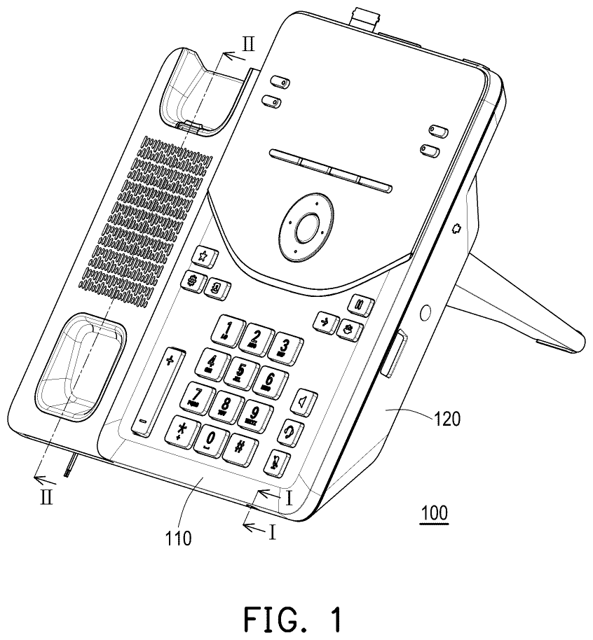

FIG. 1.

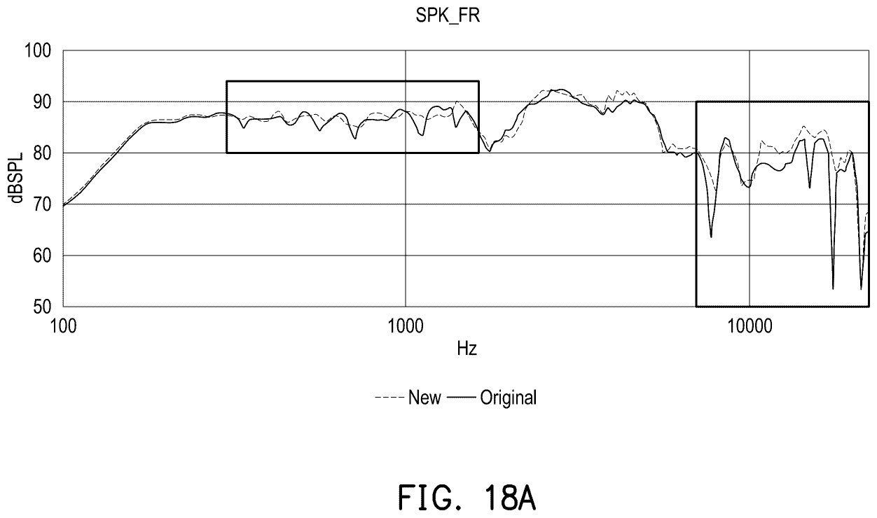

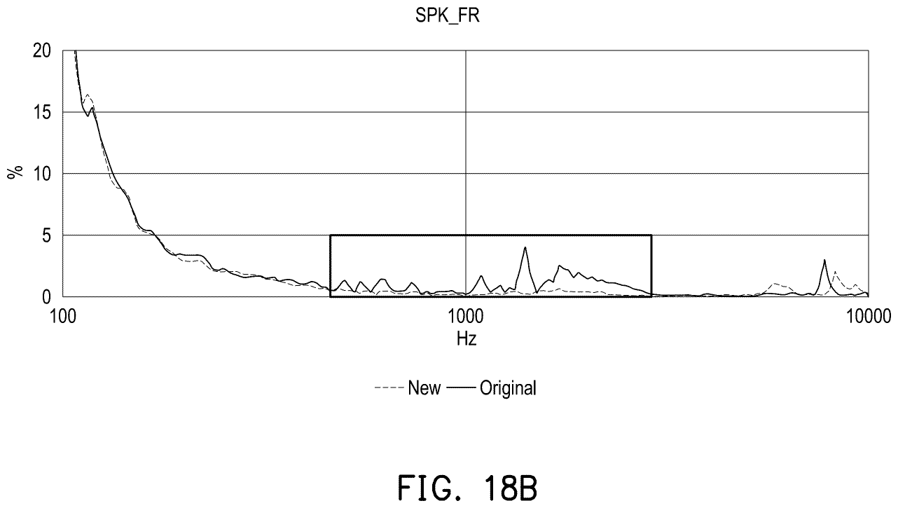

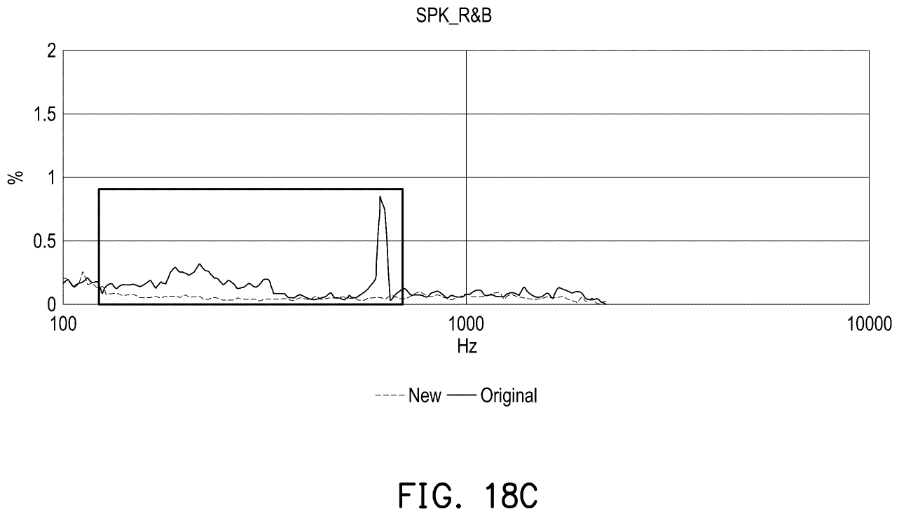

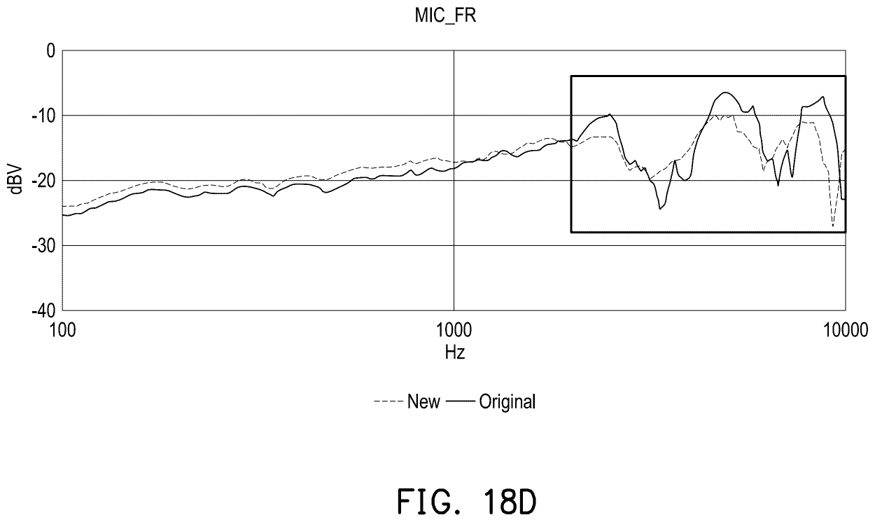

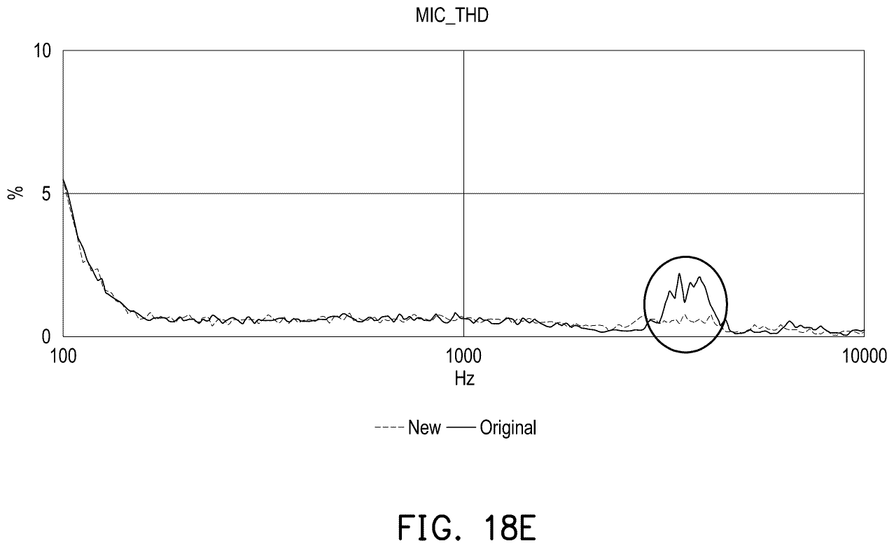

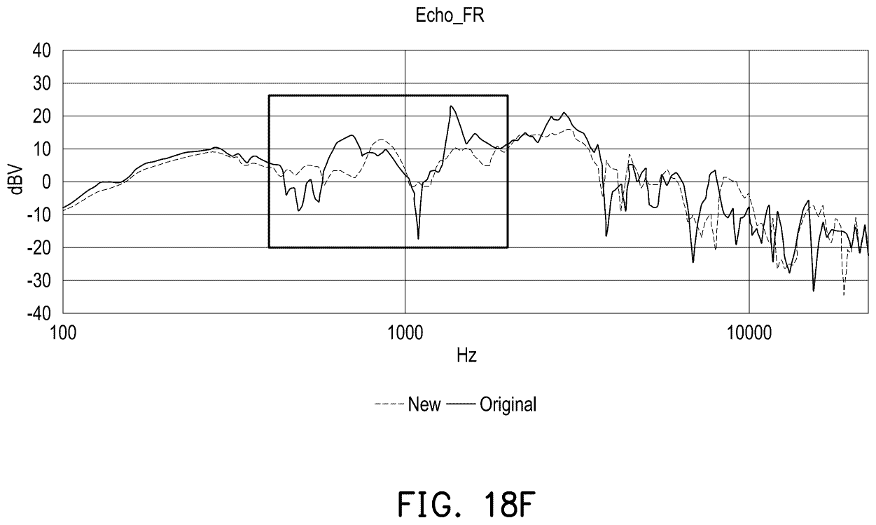

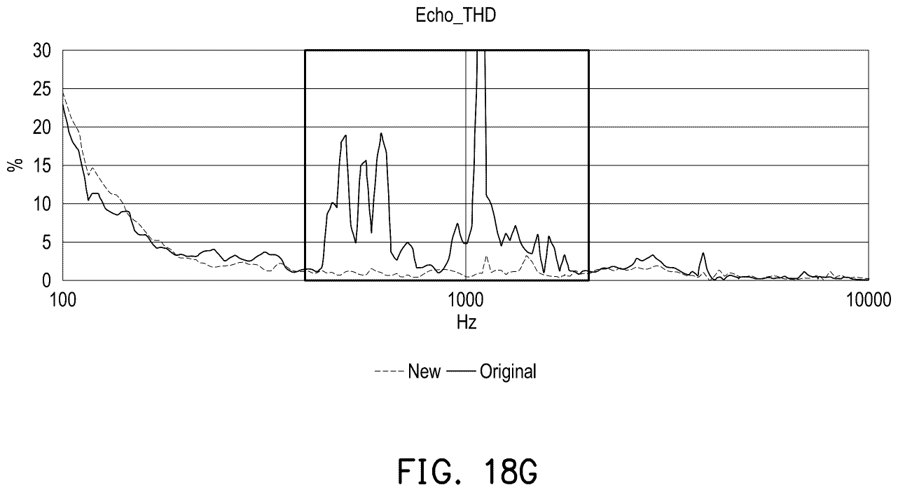

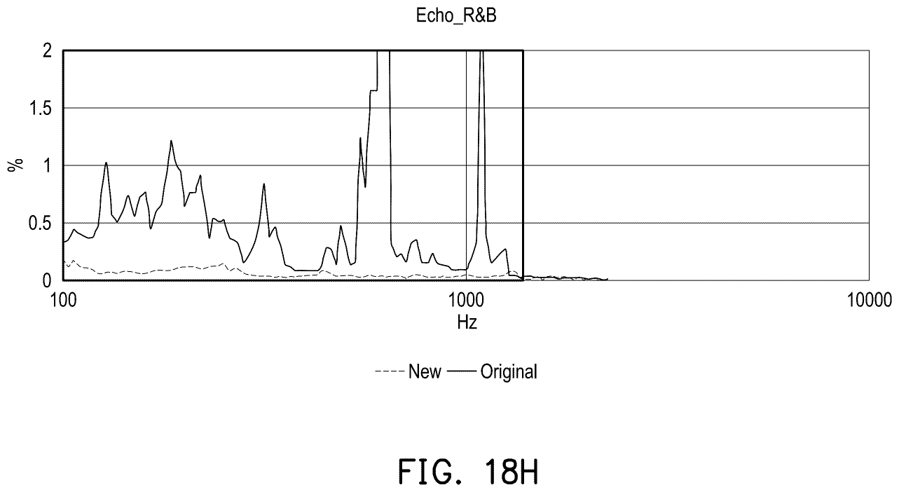

FIG. 18D and FIG. 18E are test charts of the sound receiving effect of the communication device in FIG. 1.

FIGS. 18F to 18H are test charts of the sound receiving effect and the broadcast effect of the communication device in FIG. 1.

### DESCRIPTION OF THE EMBODIMENTS

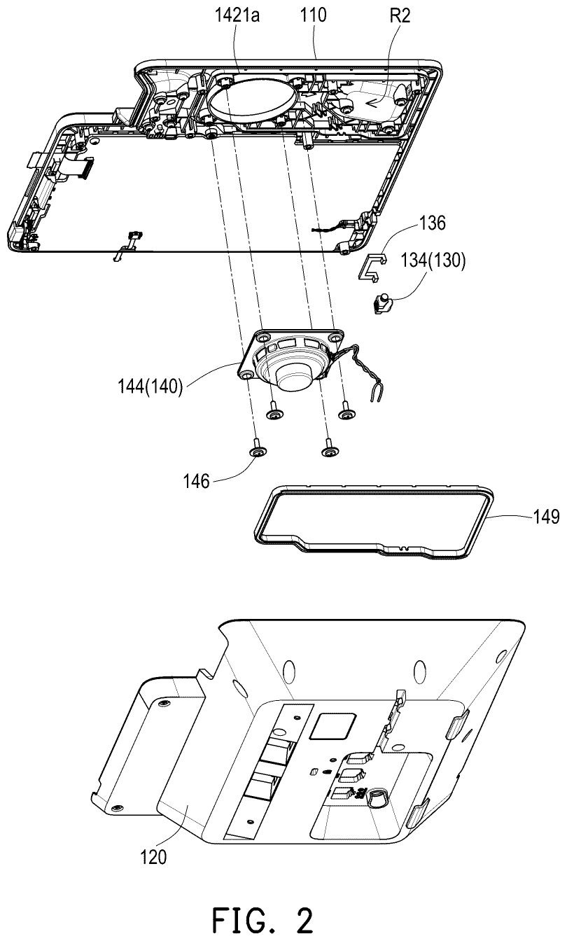

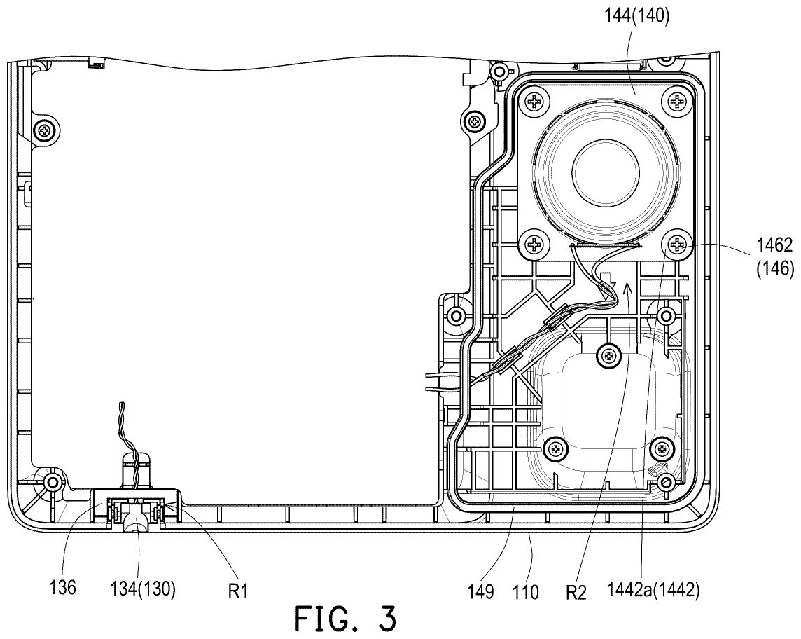

FIG. 1 is a perspective view of a communication device according to an embodiment of the disclosure. FIG. 2 is an exploded view of the communication device of FIG. 1. FIG. 3 is a partial bottom view of some components of the communication device of FIG. 2. Referring to FIGS. 1 to 3, a communication device 100 of this embodiment includes a first cover 110, a second cover 120, a microphone module 130, and a speaker module 140. The second cover 120 and the first cover 110 are assembled with each other to form a housing of the communication device 100 for accommodating the microphone module 130 and the speaker module 140.

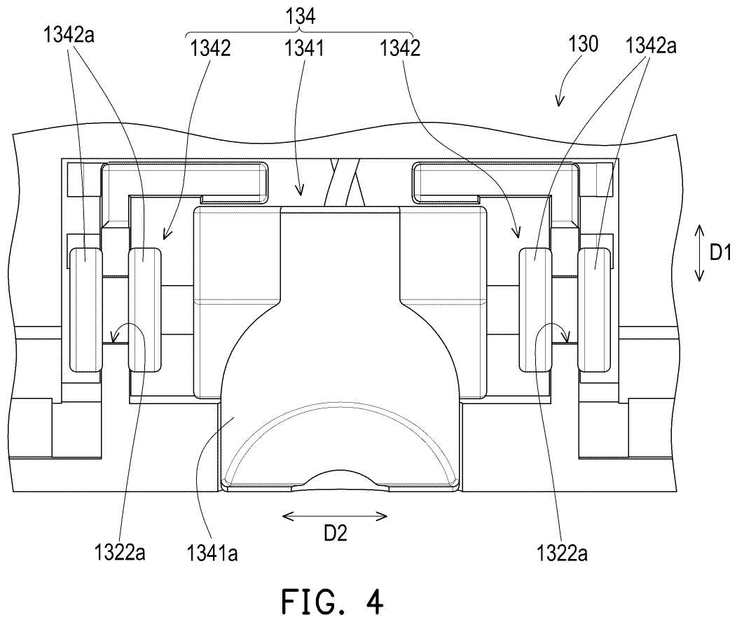

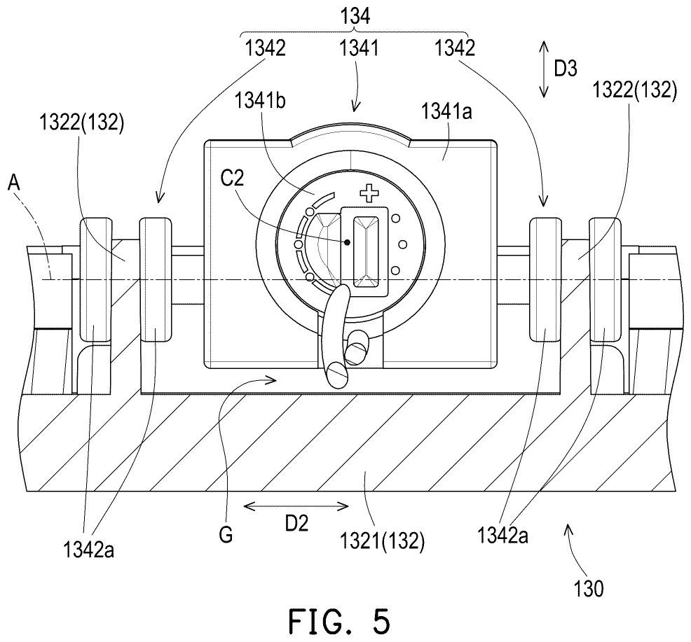

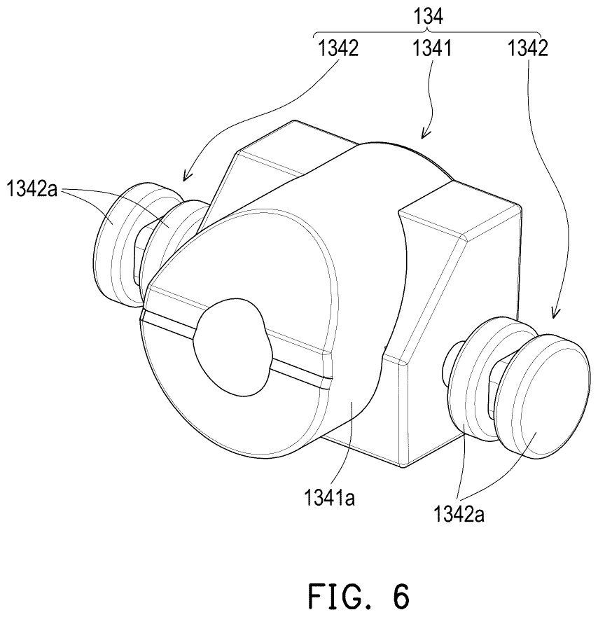

FIG. 4 is a partial enlarged view of the communication device of FIG. 3. FIG. 5 is a front view of the microphone module of FIG. 4. FIG. 6 is a perspective view of the microphone assembly of FIG. 5. Referring to FIGS. 3 to 6, the microphone module 130 of this embodiment includes a carrying structure 132 and a microphone assembly 134. The carrying structure 132 is integrally formed on the first cover 110. That is, the carrying structure 132 is a part of the first cover 110. The carrying structure 132 includes a carrying part 1321 and two supporting parts 1322. The two supporting parts 1322 are integrally formed and connected to the carrying part 1321. The microphone assembly 134 includes a microphone body part 1341 and two hanging parts 1342. The two hanging parts 1342 are respectively connected to two opposite sides of the microphone body part 1341 and hung on the two support parts 1322 respectively, so that the microphone body part 1341 is suspended on the carrying part 1321.

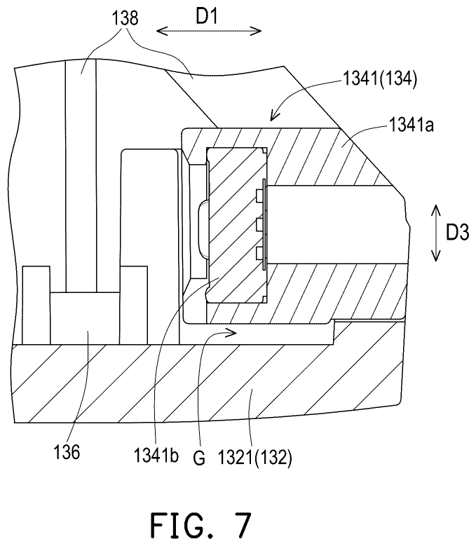

FIG. 7 is a cross-sectional view along line II of the communication device in FIG. 1. As mentioned above, in the microphone module 130 of this embodiment, the microphone body part 1341 is suspended on the carrying part 1321 through the two opposite hanging parts 1342, so that there is a gap G is between the microphone body part 1341 and the carrying part 1321 as shown in FIG. 5 and FIG. 7, thereby reducing a contact area between the microphone body part 1341 and the carrying part 1321, so as to suppress a vibration transmitted to the microphone body part 1341 via the carrying part 1321. Accordingly, the impact of the vibration of the speaker module 140 on the sound receiving quality of the microphone module 130 can be effectively suppressed.

In detail, each of the supporting parts 1322 of this embodiment has a limiting notch 1322a as shown in FIG. 4, and each of the hanging parts 1342 is limited in the limiting notch 1322a of the corresponding supporting part 1322. Accordingly, each of the support parts 1322 fixes the microphone assembly 134 in a front-rear direction D1 of the microphone assembly 134 by limiting the hanging part 1342 with the limiting notch 1322a. In addition, each of the hanging parts 1342 of this embodiment has two blocking flanges 1342a as shown in FIG. 4, and each of the supporting parts 1322 is blocked between the two blocking flanges 1342a of the corresponding hanging part 1342. Accordingly, each of the support parts 1322 fixes the microphone assembly 134 in a width direction D2 of the microphone assembly 134 as being blocked by the blocking flange 1342a.

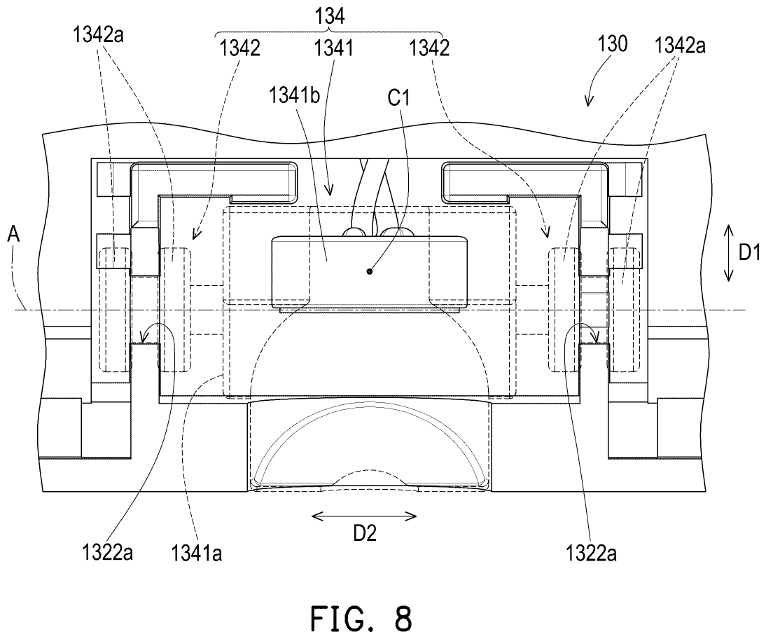

FIG. 8 is a perspective view of the microphone module of FIG. 4. Refer to FIGS. 5, 7 and 8, in this embodiment, the microphone body part 1341 includes a housing 1341a and a microphone 1341b. The two hanging parts 1342 are integrally formed and connected to two opposite sides of the housing 1341a. The microphone 1341b is configured inside the housing 1341a. A horizontal axis A passes through the two hanging parts 1342 along the width direction D2 of the microphone assembly 134. In an up-down direction D3 of the microphone assembly 134, the horizontal axis A does not pass through a geometric center C1 of the microphone 1341b as shown in FIG. 8. In addition, in the front-rear direction D1 of the microphone assembly 134, the horizontal axis A does not pass through the geometric center C2 of the microphone body part 1341 as shown in FIG. 5.

Referring to FIG. 2, FIG. 3, and FIG. 7, furthermore, the microphone module 130 of this embodiment further includes a sealing member 136 and a covering structure 138. A material of the sealing member 136 is, for example, ethylene vinyl acetate (EVA) or other appropriate sealing materials. The covering structure 138 is integrally formed on the second cover 120. That is, the covering structure 138 is a part of the second cover 120. The covering structure 138 is used to block the microphone assembly 134 and fix the microphone assembly 134 in the up-down direction D3 of the microphone assembly 134. The sealing member 136 is compressed between the covering structure 138 and the carrying part 1321 and defines a sealing area R1 (marked in FIG. 3). The microphone assembly 134 is located within the sealing area R1 and the speaker module 140 is located outside the sealing area R1. Accordingly, the microphone assembly 134 can be prevented from receiving external noise.

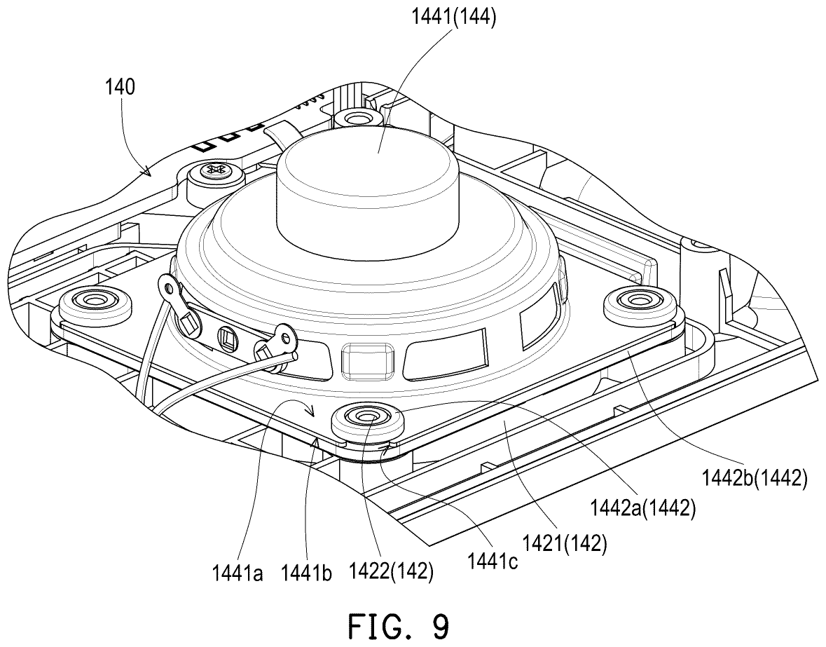

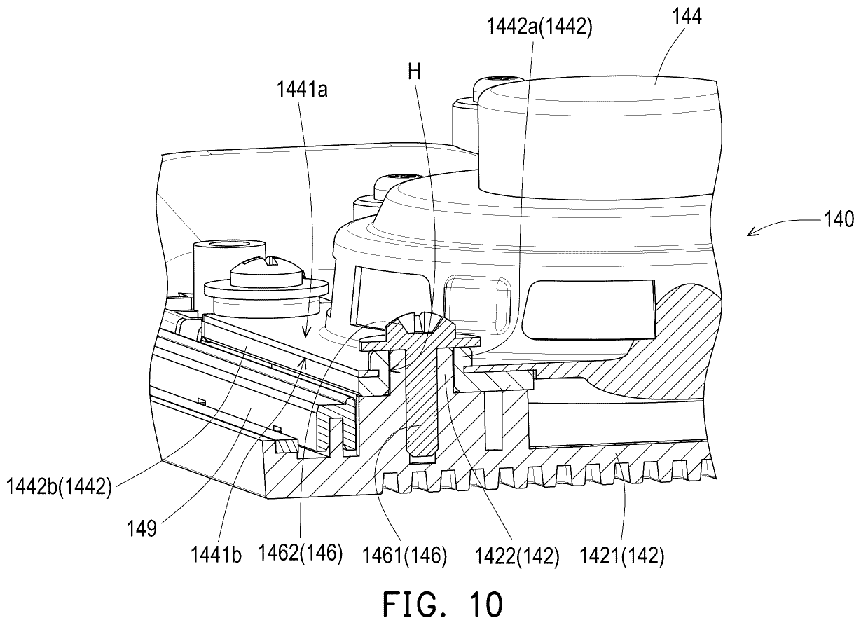

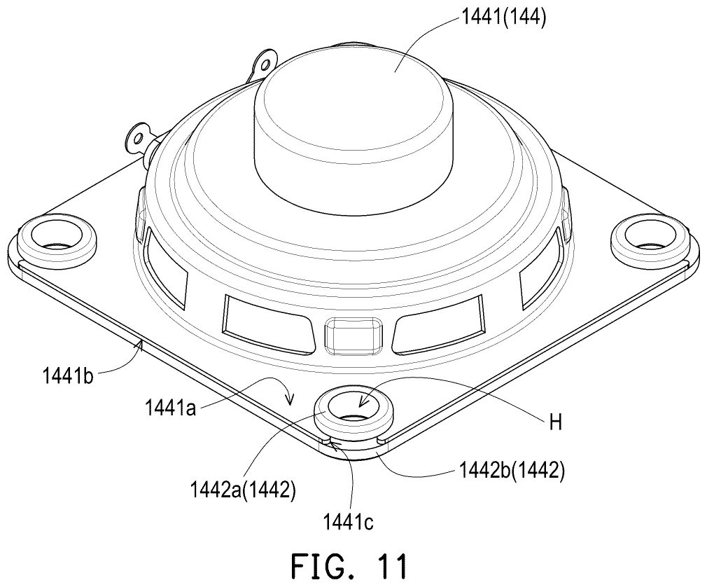

FIG. 9 is a partial perspective view of the communication device of FIG. 3. FIG. 10 illustrates a partial structure of the speaker module of FIG. 9. FIG. 11 is a perspective view of a speaker assembly of FIG. 9. Referring to FIG. 3, FIG. 9, and FIG. 10, the speaker module 140 of this embodiment includes a carrying structure 142, a speaker assembly 144, and multiple screwing members 146. The carrying structure 142 is integrally formed on the first cover 110. That is, the carrying structure 142 is a part of the first cover 110. The carrying structure 142 includes a carrying part 1421 and multiple assembly parts 1422. The assembly parts 1422 are connected to the carrying part 1421.

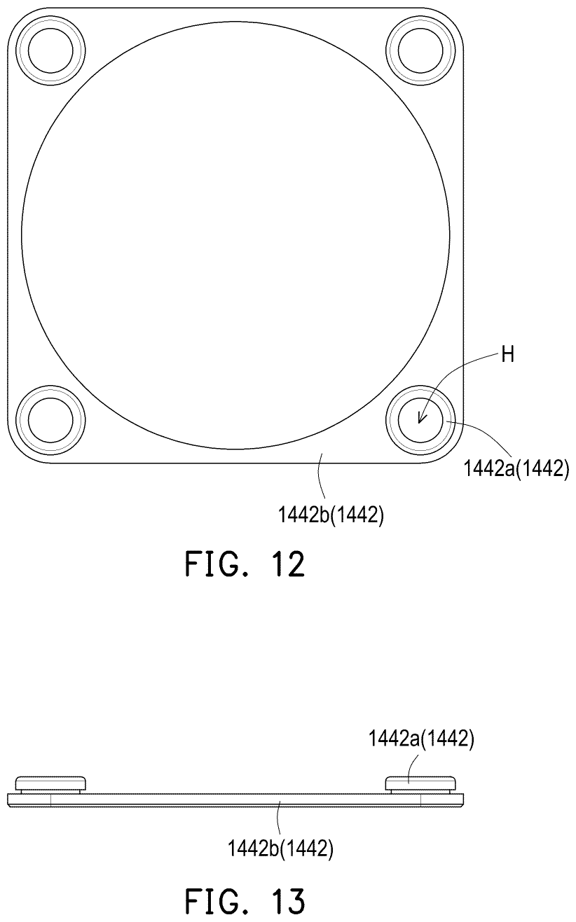

FIG. 12 is a bottom view of a buffer structure of FIG. 11. FIG. 13 is a side view of the buffer structure of FIG. 12. Referring to FIGS. 9 to 13, the speaker assembly 144 is disposed on the carrying part 1421 and includes a speaker body part 1441 and a buffer structure 1442. A peripheral edge of the speaker body part 1441 has a first surface 1441a and a second surface 1441b relative to each other and has multiple assembly notches 1441c. The buffer structure 1442 is made of, for example, rubber or other suitable buffer materials and includes multiple buffer parts 1442a and a buffer layer 1442b. The buffer parts 1442a are located on the first surface 1441a of the speaker body part 1441. The buffer layer 1442b is located on the second surface 1441b of the speaker body part 1441 and is integrally connected to the buffer part 1442a through the assembly notch 1441c. The peripheral edge of the speaker body part 1441 is sandwiched between the buffer part 1442a and the buffer layer 1442b. The buffer layer 1442b is sandwiched between the second surface 1441b of the speaker body part 1441 and the carrying part 1421.

The buffer structure 1442 has multiple through holes H, and the through holes H penetrate from the buffer parts 1442a to the buffer layer 1442b respectively. The assembly parts 1422 are inserted into the through holes H and penetrate the buffer parts 1442a respectively. Screwing parts 1461 of the screwing members 146 are respectively screwed on the assembly parts 1422. The buffer parts 1442a are sandwiched between heads 1462 of the screwing member 146 and the first surface 1441a of the speaker body part 1441.

As mentioned above, in the speaker module 140 of this embodiment, the buffer part 1442a of the buffer structure 1442 is sandwiched between the screwing member 146 and the speaker body part 1441 and adjacent to the assembly part 1422, so that vibration transmitted by the speaker body part 1441 to the screwing member 146 and the assembly part 1422 can be suppressed by a buffering effect of the buffer part 1442a. Furthermore, the buffer layer 1442b of the buffer structure 1442 is sandwiched between the speaker body part 1441 and the carrying part 1421 to have an airtight effect. Accordingly, the impact of the vibration of the speaker body part 1441 on the sound receiving quality of the microphone module 130 and the broadcast quality of the speaker module 140 can be effectively suppressed.

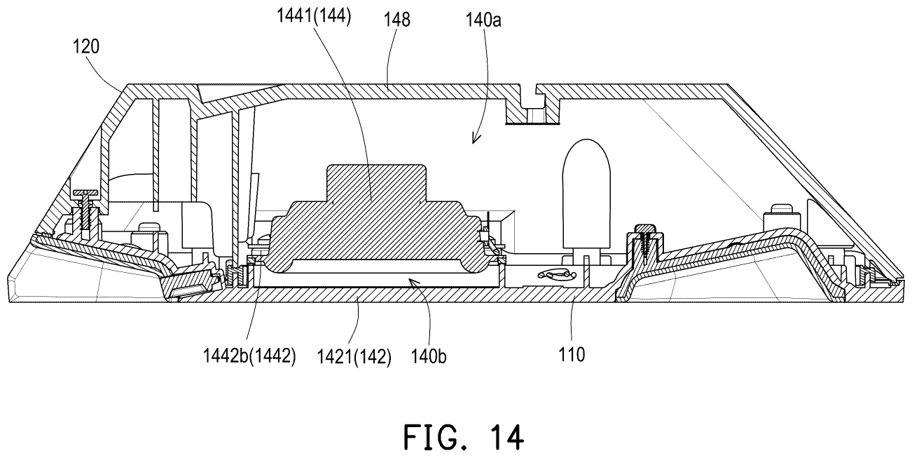

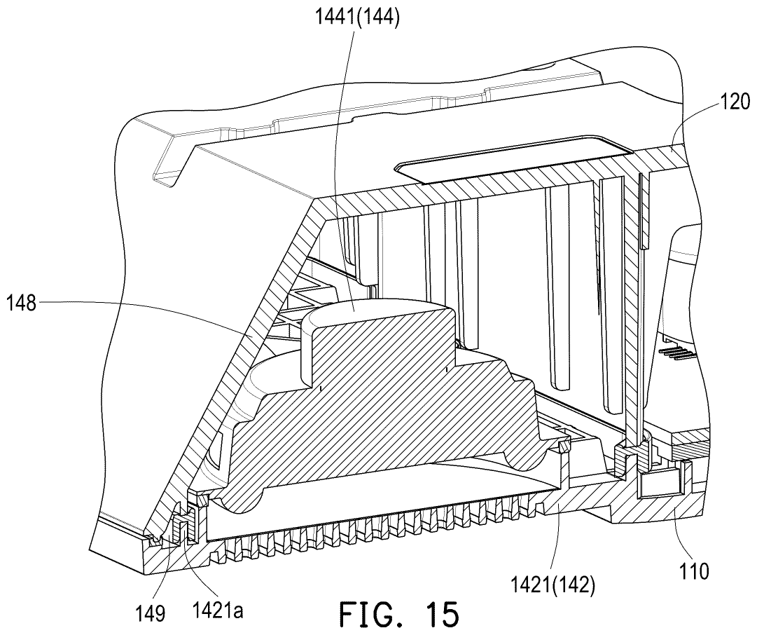

FIG. 14 is a cross-sectional view along line II-II of the communication device of FIG. 1. Referring to FIG. 14, in detail, the speaker module 140 of this embodiment further includes a covering structure 148. The covering structure 148 is integrally formed on the second cover 120. That is, the covering structure 148 is a part of the second cover 120. A rear sound cavity 140a is formed between the covering structure 148 and the buffer structure 1442, and a front sound cavity 140b is formed between the buffer structure 1442 and the carrying part 1421. Due to the airtight effect provided by the buffer layer 1442b of the buffer structure 1442, the rear sound cavity 140a and the front sound cavity 140b are independent of each other. As mentioned above, the rear sound cavity 140a and the front sound cavity 140b are separated in the speaker module 140 through the buffer structure 1442, so that the effective volumes of the rear sound cavity 140a and the front sound cavity 140b can be accurately optimized according to the requirements of acoustic design. In addition, as mentioned above, the covering structure 148 integrally formed on the second cover 120 and the carrying part 1421 integrally formed on the first cover 110 are used to define the rear sound cavity 140a and the front sound cavity 140b, so no additional design of sound cavity housing is required to save manufacturing and assembly costs.

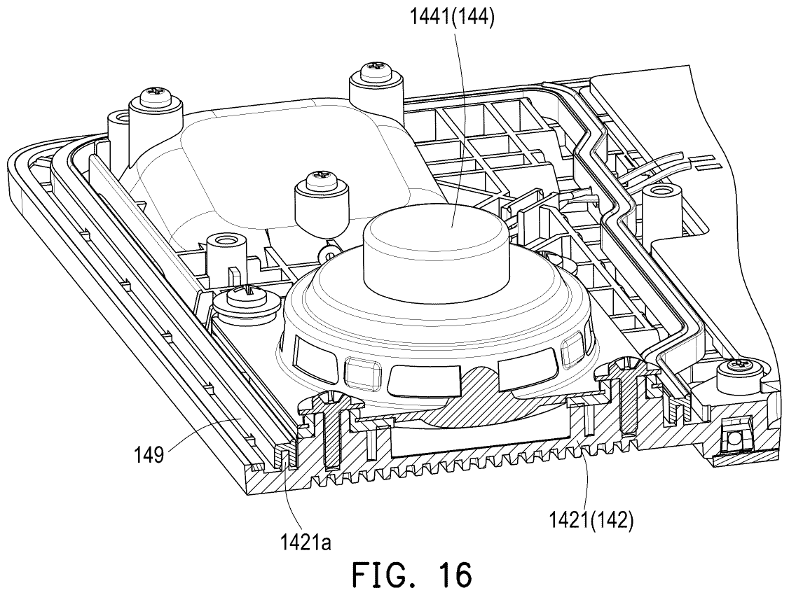

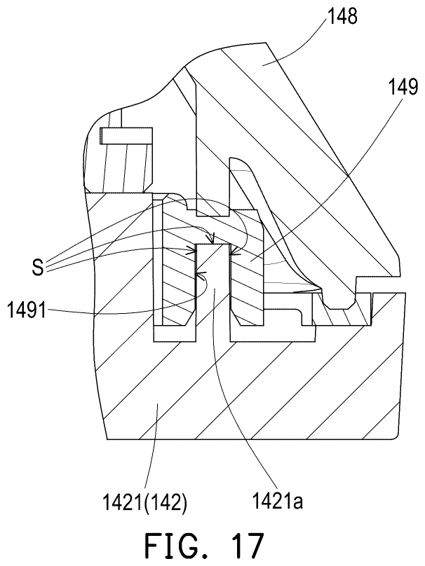

FIGS. 15 and 16 are perspective views of the partial structure of the speaker module of FIG. 14. FIG. 17 is an enlarged partial cross-sectional view of the speaker module of FIG. 15. Referring to FIGS. 2, 3, and 15 to 17, the speaker module 140 of this embodiment further includes an annular sealing structure 149. The carrying part 1421 has an annular flange 1421a. The annular flange 1421a defines a sound cavity area R2 (marked in FIGS. 2 and 3). The speaker assembly 144 is located inside the sound cavity area R2, and the microphone module 130 is located outside the sound cavity area R2. That is, the speaker assembly 144 is located at the inner side of the annular flange 1421a to be surrounded by the annular flange 1421a, and the microphone module 130 is located at the outer side of the annular flange 1421a. The annular sealing structure 149 is made of, for example, rubber or other suitable sealing materials and has a groove 1491 (marked in FIG. 17). The annular flange 1421a is embedded in the groove 1491, and the annular sealing structure 149 is compressed between the covering structure 148 and the annular flange 1421a. Accordingly, the annular sealing structure 149 and the annular flange 1421a are in contact with each other through three contact surfaces S (marked in FIG. 17), so that the rear sound cavity 140a and the front sound cavity 140b can be properly sealed in the sound cavity area R2.

FIGS. 18A to 18C are test charts of the broadcast effect of the communication device in FIG. 1. FIG. 18D and FIG. 18E are test charts of the sound receiving effect of the communication device in FIG. 1. FIGS. 18F to 18H are test charts of the sound receiving effect and the broadcast effect of the communication device in FIG. 1. As shown in FIG. 18A, in terms of SPK FR of the speaker module 140, the curve is smooth from 300 Hz to 1.5 KHz and there is no obvious dip after 7 KHz. As shown in FIG. 18B, in terms of SPK THD of the speaker module 140, the vibration is obviously effectively suppressed, especially a distortion at 1 to 3 KHz is significantly reduced. As shown in FIG. 18C, in terms of SPK R&B of the speaker module 140, the vibration is obviously effectively suppressed, and the overall vibration is reduced at 100 Hz to 700 Hz (most obvious at 600 Hz). As shown in FIG. 18D, in terms of MIC FR of the microphone module 130, the overall curve is smooth, and there is no obvious dip or peek after 2 KHz. As shown in FIG. 18E, in terms of MIC THD of the microphone module 130, the vibration is obviously effectively suppressed, especially the distortion at 3 to 4 KHz is significantly reduced. As shown in FIG. 18F, in terms of Echo FR of the speaker module 140 and the microphone module 130, the curve is smooth and there are no obvious dips and peeks. As shown in FIG. 18G, in terms of Echo THD of the speaker module 140 and the microphone module 130, the vibration is obviously effectively suppressed, and the overall distortion is significantly reduced in the mid-frequency. As shown in FIG. 18H, in term of Echo R&B of the speaker module 140 and the microphone module 130, the vibration is obviously effectively suppressed, and the overall R&B is significantly reduced

To sum up, in the microphone module of the disclosure, the microphone body part is suspended on the carrying part through the two opposite hanging parts, so that there is the gap between the microphone body part and the carrying part, thereby reducing the contact area between the microphone body part and the carrying part to suppress the vibration transmitted to the microphone body part through the carrying part. Moreover, the buffer layer of the buffer structure is sandwiched between the speaker body part and the carrying part to have the airtight effect. In addition, in the speaker module of the disclosure, the buffer part of the buffer structure is sandwiched between the screwing member and the speaker body part and adjacent to the assembly part, so that the vibration transmitted to the screwing member and the assembly part through the speaker body part can be suppressed by the buffering effect of the buffer part. Accordingly, the impact of the vibration of the speaker module on the sound receiving quality and the broadcast quality can be effectively suppressed.

What is claimed is:

1. A microphone module, comprising:
a carrying structure, comprising a carrying part and two support parts, wherein the two support parts are connected to the carrying part; and
a microphone assembly, comprising a microphone body part and two hanging parts, wherein the microphone body is suspended on the carrying part, and the two hanging parts are respectively connected to two opposite sides of the microphone body part and hung on the two support parts respectively.

2. The microphone module according to claim 1, wherein each of the supporting parts has a limiting notch, and each of the hanging parts is limited in the limiting notch of the corresponding supporting part.

3. The microphone module according to claim 1, wherein each of the hanging parts has two blocking flanges, and each of the support parts is blocked between the two blocking flanges of the corresponding hanging part.

4. The microphone module according to claim 1, wherein the microphone body part comprises a housing and a microphone, wherein the two hanging parts are connected to two opposite sides of the housing, and the microphone is configured in the housing.

5. The microphone module according to claim 4, wherein the two hanging parts are integrally formed and connected to the housing.

6. The microphone module according to claim 4, wherein a horizontal axis passes through the two hanging parts along a width direction of the microphone assembly, and in an up-down direction of the microphone assembly, the horizontal axis does not pass through a geometric center of the microphone.

7. The microphone module according to claim 1, wherein a horizontal axis passes through the two hanging parts along a width direction of the microphone assembly, and in a front-rear direction of the microphone assembly, the horizontal axis does not pass through a geometry center of the microphone body part.

8. The microphone module according to claim 1, further comprising a sealing member and a covering structure, wherein the sealing member is compressed between the covering structure and the carrying part and defines a sealing area, and the microphone assembly is located in the sealing area.

9. A speaker module, comprising:
a carrying structure, comprising a carrying part and an assembly part, wherein the assembly part is connected to the carrying part;
a speaker assembly, configured on the carrying part and comprising a speaker body part and a buffer structure, wherein the buffer structure comprises a buffer part, the buffer part is located on a first surface of the speaker body part, and the assembly part penetrates the buffer part; and
a screwing member, screwed on the assembly part, wherein the buffer part is sandwiched between the screwing member and the first surface of the speaker body part.

10. The speaker module according to claim 9, wherein the assembly part, the buffer part, and the screwing member are all in plural numbers, and the assembly parts respectively penetrate the buffer parts, and the screwing members are respectively screwed on the assembly parts.

11. The speaker module according to claim 9, wherein the buffer structure comprises a buffer layer, the buffer layer is located on a second surface of the speaker body part relative to the first surface and connected to the buffer part, and the buffer layer is sandwiched between the second surface of the speaker body part and the carrying part.

12. The speaker module according to claim 11, wherein a peripheral edge of the speaker body part has an assembly notch, and the buffer part and the buffer layer are connected to each other through the assembly notch.

13. The speaker module according to claim 9, further comprising a covering structure and an annular sealing structure, wherein the carrying part has an annular flange, the annular flange defines a sound cavity area, the speaker assembly is located in the sound cavity area, the annular sealing structure has a groove, the annular flange is embedded in the groove, and the annular sealing structure is compressed between the covering structure and the annular flange.

14. The speaker module according to claim 9, further comprising a covering structure, wherein a rear sound cavity is formed between the covering structure and the buffer structure, and a front sound cavity is formed between the buffer structure and the carrying part.

15. A communication device, comprising:
a first cover;
a microphone module, comprising a carrying structure and a microphone assembly, wherein the carrying structure is formed on the first cover and comprises a carrying part and two supporting parts, the two supporting parts are connected to the carrying part, the microphone assembly comprises a microphone body part and two hanging parts, the microphone body is suspended on the carrying part, and the two hanging parts are respectively connected to two opposite sides of the microphone body part and hung on the two supporting parts respectively; and
a speaker module, comprising another carrying structure, a speaker assembly, and a screwing member, wherein the another carrying structure is formed on the first cover and comprises another carrying part and an assembly part, the assembly part is connected to the another carrying part, the speaker assembly is configured on the another carrying part, and comprises a speaker body part and a buffer structure, the buffer structure comprises a buffer part, the buffer part is located on a first surface of the speaker body part, the assembly part penetrates the buffer part, the screwing member is screwed on the assembly part, and the buffer part is sandwiched between the screwing member and the first surface of the speaker body part.

16. The communication device according to claim 15, further comprising a second cover, wherein the second cover is assembled to the first cover, the microphone module further comprises a sealing member and a covering structure, the covering structure is formed on the second cover, the sealing member is compressed between the covering structure and the carrying part and defines a sealing area, and the microphone assembly is located in the sealing area.

17. The communication device according to claim 16, wherein the speaker module is located outside the sealing area.

18. The communication device according to claim 15, further comprising a second cover, wherein the second cover is assembled to the first cover, the speaker module further comprises a covering structure and an annular sealing structure, the covering structure is formed on the second cover, the carrying part has an annular flange, the annular flange defines a sound cavity area, the speaker assembly is located in the sound cavity area, the annular sealing structure has a groove, the annular flange is embedded in the groove, and the annular sealing structure is compressed between the covering structure and the annular flange.

19. The communication device according to claim 18, wherein the microphone module is located outside the sound cavity area.

20. The communication device according to claim 15, further comprising a second cover, wherein the second cover is assembled to the first cover, the speaker module further comprises a covering structure, the covering structure is formed on the second cover, a rear sound cavity is formed between the covering structure and the buffer structure, and a front sound cavity is formed between the buffer structure and the another carrying part.
